(19) United States
(12) Patent Application Publication
(10) Pub. No.: US 2009/0120554 A1
(43) Pub. Date: May 14, 2009

(54) Tyre with Corrugated Sidewalls

(76) Inventor: Jose Merino, Riom (FR)

Correspondence Address: BUCHANAN, INGERSOLL & ROONEY PC, POST OFFICE BOX 1404, ALEXANDRIA, VA, 22313-1404, US

(21) Appl. No.: 11/921,450

(22) PCT Filed: May 15, 2006
(86) PCT No.: PCT/EP2006/062299

§ 371 Date: Dec. 3, 2007

(30) Foreign Application Priority Data
Jun. 2, 2005 (FR) 0505669

(51) Int. Cl. B60C 9/08; B60C 9/00

(52) U.S. Cl. 152/556

(57) ABSTRACT

A tire includes at least one reinforcing structure of the carcass type anchored on each side in a bead. Each bead is extended radially outwards by a sidewall. The reinforcing structure extends circumferentially from the bead towards the sidewall and is arranged in such a way that, in the substantially median portions of the sidewall, the threads of the reinforcing structure having different axial positions so as to form a succession of substantially regular corrugations along the circumferential path, thus forming a corrugated circumferential thread profile.

### BACKGROUND

The present invention relates to tires. More specifically, it relates to a tire comprising a particular arrangement of the threads of the reinforcing structure of the carcass type in the sidewalls making it possible, on the one hand, to obtain flexible sidewalls able to impart qualities, particularly those of comfort and rolling resistance, that are particularly favourable to low profile tires and, on the other hand, to obtain ultra low profile tires or tires with very short sidewalls.

Vehicles are increasingly being fitted with low profile tires. These types of tires are desired for their intrinsic qualities in terms of responsiveness and feel and the sporty driving that they have to offer. Now, these qualities are often obtained at the expense of comfort. Indeed, the shorter the sidewalls, the lower the level of comfort. In certain instances, the degree of rigidity achieved is such that the vehicle becomes uncomfortable in certain very unfavourable cases, such as, for example, when driving over very poor road surfaces.

Document EP 0 667 250 (corresponding to Suzuki et al. U.S. Pat. No. 5,616,198) describes a tire with handleability characteristics that have been improved through the use of circumferential reinforcements that have different coefficients of thermal contraction. Thus, after curing, some of the threads—those with the high coefficient—occupy a more inward axial position than others—those with the lower coefficient. Naturally, these various positions are found on the entire profile of the tire. A process such as this does not allow the differences in axial position to be concentrated in a single portion of the profile.

Document WO 2004/045870 (U.S. Publication No. 2005/0263230) describes a tire with extended mobility in which the reinforcing threads are identical or similar and have different axial positions. This tire entails the use of circumferential reinforcements midway up the sidewalls in order, in particular, to prevent or limit collapse when the sidewalls are highly stressed.

### SUMMARY OF INVENTION

In order to alleviate these various disadvantages, the invention provides a tire comprising at least one reinforcing structure of the carcass type anchored on each side of the tire in a bead, the base of which reinforcement structure is intended to be mounted on a rim seat. Each bead is extended radially outwards by a sidewall. The sidewalls, radially towards the outside, are joined to a tread, the reinforcing structure of the carcass type extending circumferentially from the bead towards the said sidewall, a crown reinforcement, each of the beads also comprising an anchoring region securing the reinforcing structure in each of the said beads, the said reinforcing structure of the carcass type being arranged in such a way that, on the one hand, in the substantially median portion of the sidewall, the threads of the said reinforcing structure have different axial positions on the circumference so as to form a sidewall region that has corrugations comprising, along the circumferential path, a succession of substantially regular corrugations forming a corrugated circumferential profile and, on the other hand, outside of this region all the threads of the structure of the carcass type occupy substantially the same axial position.

The solution proposed by the present invention makes it possible to set aside some of the disadvantages of tires of conventional type. Furthermore, this type of architecture is particularly advantageous in tires with short sidewalls. It allows the boundaries of conventional design to be crossed and therefore allows tires to be designed with very short sidewalls. Furthermore, and unexpectedly, it has been found that the circumferential reinforcements midway up the sidewall, such as those set out in document WO 2004/045870, can be omitted, without in any way compromising the operational characteristics of the tire. The resulting extra flexibility allows the size of the sidewalls to be reduced, in order thus to produce tires with short or very short sidewalls.

According to an advantageous embodiment, the sidewall region with corrugations extends radially into the sidewall between the bead and the crown region.

In the said sidewall region with corrugations, the various possible positions of the threads of the reinforcing structure advantageously lie between the axially innermost reinforcing structure path and the axially outermost reinforcing structure path.

According to an advantageous alternative form, the outer surface of the sidewall of the tire, in the region in which the reinforcing structure has the corrugations, also has a corrugated circumferential profile, substantially corresponding to the profile formed by the reinforcing structure. The sidewall corrugations allow the internal architectural characteristics of the tire to be seen visibly. The latter aspect makes it possible, for example, to better identify this type of technology. In an alternative form, the exterior surface of the sidewall is substantially straight. The special architecture of the reinforcing structure is therefore not revealed, and the profile of the sidewall is configured in the conventional way.

According to various embodiments, the axial position of a reinforcing thread, for a given circumferential position of the corrugated circumferential profile, is either substantially symmetric in each sidewall with respect to the median plane of the tire, or substantially opposed in each sidewall. Thus, the paths of the reinforcing structures of the carcass type may be arranged in two types of configuration, namely, for example, a “phase-opposition” configuration in which the axial position of a reinforcing thread, for a given circumferential position of the corrugated circumferential profile, is substantially symmetric in each sidewall with respect to the median plane of the tire, or an “in-phase” configuration in which the axial position of a portion of reinforcing structure, for a given circumferential position of the corrugated circumferential profile, is substantially opposed in each sidewall.

Advantageously, the ratio h/H ranges (described later) between 0.2 and 0.75 and more particularly between 0.2 and 0.50.

According to an advantageous embodiment, the distance D (described later) is at least 1.25d.

The distances D and d advantageously have the following relationship: 1.5d<D<5d.

### BRIEF DESCRIPTION OF THE DRAWING

All the embodiment details are given in the description which follows, supplemented by the accompanying figures.

FIG. 1a is a cross-sectional view through a portion of a tire within a plane containing the tire's axis, showing a bead, a sidewall, half a crown, and a carcass-type of reinforcement according to the invention anchored by a first anchoring technique.

FIG. 1b is a view similar to FIG. 1a showing the carcass-type reinforcement anchored by a second anchoring technique.

FIG. 2a is a schematic side view of a tire indicating three separate radially spaced positions of the tire's sidewall.

FIG. 2b is a cross-sectional view of a first embodiment of carcass-type reinforcement taken at either of the positions represented by the lines B-B′ in FIG. 2a.

FIG. 2c is a cross-sectional view of the first embodiment of carcass-type reinforcement taken at the position represented by the line A-A′ in FIG. 2a.

FIG. 3a is a cross-sectional view of a second embodiment of the carcass-type reinforcement taken at the position represented by the line A-A′ in FIG. 2a.

FIG. 3b is a cross-sectional view of a third embodiment of the carcass-type reinforcement taken at the position represented by the line A-A′ in FIG. 2a.

FIG. 4a is a schematic cross section through one radial half of a tire showing carcass-type reinforcement threads arranged asymmetrically in peak-to-valley relationship.

FIG. 4b is a view similar to FIG. 4a showing an alternative arrangement of carcass-type reinforcement threads arranged in peak-to-peak relationship.

FIG. 5a is a schematic side view of a tire indicating two radially spaced positions of the tire's sidewall and an angular section of the lowermost one of those positions.

FIG. 5b is a cross-sectional view through the tire of FIG. 5a within a plane containing the tire's axis, showing the shapes of the tire sidewall at the two positions represented by lines A-A′ (taut) and B-B′ (corrugated), respectively.

### DETAILED DESCRIPTION OF PREFERRED EMBODIMENTS

The reinforcing structure or reinforcement of tires is currently—and usually—made up of a stack of one or more plies conventionally known as “carcass plies”, “crown plies” etc. This way of naming the reinforcing structures stems from the process of manufacture which consists in producing a series of semi-finished products in the form of plies, provided with threadlike reinforcements, often longitudinal, which are then assembled or stacked to make a tire preform. The plies are manufactured flat, with large dimensions, and then cut to suit the dimensions of a given product. The plies are also assembled, initially, substantially flat. The preform thus manufactured is then shaped into the toroidal profile typical of tires. The semi-finished so-called “finishing” products are then applied to the preform, to obtain a product that is ready to be cured.

A “conventional” type of process such as this entails, particularly during the phase of manufacturing the tire preform, the use of an anchoring element (typically a bead wire), which is used to anchor or secure the carcass reinforcement in the region of the beads of the tire. Thus, in this type of process, a portion of all the plies (or just some of the plies) that make up the carcass reinforcement is wrapped around a bead wire positioned in the bead of the tire. Thus, the carcass reinforcement is anchored in the bead.

The fact that this conventional type of process is widespread throughout the tire manufacturing industry, in spite of there being numerous variants of producing the plies and the assemblies, has led those skilled in the art to employ a vocabulary hinged on the process; hence the terminology generally accepted which in particular includes the terms “plies”, “carcass”, “bead wire”, “shaping” to denote the change from a flat profile to a toroidal profile, etc.

However, nowadays there are tires which do not strictly speaking have any “plies” or “bead wires” consistent with the above definitions. For example, document EP 0 582 196 describes tires manufactured without the use of semi-finished products in the form of plies. For example, the threads of the various reinforcing structures are applied directly to the adjacent layers of rubber mixes, all of this being applied in successive layers to a toroidal core the shape of which allows a profile similar to the final profile of the tire being manufactured to be obtained directly. Thus, in this case, there are no longer any “semi-finished” products, or any “plies”, or any “bead wires”. The base products, such as the rubber mixes and the reinforcing elements in the form of threads or filaments, are applied directly to the core. Since this core is of toroidal shape, there is no longer any need to shape the preform in order to change from a flat profile to a profile in the shape of a torus.

Incidentally, the tires described in that document do not have any “traditional” wrapping of the carcass ply around a bead wire. That type of anchorage is replaced by an arrangement whereby circumferential filaments are positioned adjacent to the said sidewall reinforcing structure, everything being embedded in an anchoring or bonding rubber mix.

There are also processes of assembly onto a toroidal core that employ semi-finished products specially adapted for rapid, effective and simple placement on a central core. Finally, it is also possible to use a hybrid comprising both certain semi-finished products for achieving certain architectural aspects (such as plies, bead wires, etc.) while others are achieved by applying rubber mixes and/or reinforcing elements in the form of filaments, directly.

In this document, in order to take account of recent technological evolutions both in the field of manufacture and in the design of products, the conventional terms such as “plies”, “bead wires”, etc., are advantageously replaced with terms that are neutral or independent of the type of process used. Thus, the term “reinforcement of the carcass type” or “sidewall reinforcement” can be used to denote the reinforcing threads of a carcass ply in the conventional process and the corresponding threads, generally applied to the sidewalls, of a tire produced according to a process that does not involve semi-finished products. The term “anchoring region”, for its part, can denote the “traditional” wrapping of the carcass ply around a bead wire in a conventional process just as easily as it can denote the assembly formed by the circumferential filaments, the rubber mix and the adjacent sidewall reinforcing portions of a bottom region manufactured using a process that involves application onto a toroidal core.

In the present description, the term “thread” denotes quite generally both monofilaments and multifilaments or assemblies such as cable, plied yarn or alternatively any type of equivalent assembly, and does so irrespective of the nature and treatment of these threads. These may, for example, be surface treatments, coating or preglueing to encourage them to adhere to the rubber. The expression “unitary thread” denotes a thread made up of a single element, without assembly. The term “multifilament” on the other hand denotes an assembly of at least two unitary elements to form a cable, a plied yarn, etc.

It is known that the carcass ply or plies are conventionally wrapped around a bead wire. The bead wire thus has a function of anchoring the carcass. Thus, in particular, it bears the tension that develops in the carcass threads for example under the effect of the inflation pressure. The arrangement described in the present document is able to afford a similar anchoring function. It is also known to use the traditional type of bead wire in order to ensure that the bead tightened onto a rim. The arrangement described in this document also allows a similar tightening function to be performed.

In this description, a “bonding” rubber or mix is to be understood as meaning the rubber mix that may be in contact with the reinforcing threads, that adheres thereto and is able to fill the gaps between adjacent threads.

“Contact” between a thread and a layer of bonding mix is to be understood as meaning that at least part of the external circumference of the thread is in close contact with the rubber mix that makes up the bonding mix.

Those portions of the tire usually of low flexural rigidity situated between the crown and the beads are termed the “sidewalls”. The rubber mixes situated axially on the outside relative to the threads of the carcass reinforcing structure and their bonding mix are termed the “sidewall mix”. These mixes usually have a low elastic modulus.

That portion of the tire that is adjacent to the sidewall radially on the inside is termed the “bead”.

The “elastic modulus” of a rubber mix is understood to be a secant extension modulus obtained for the order of 10% uniaxial extension deformation at ambient temperature.

As a reminder, “radially upwards” or “radially upper” or “radially outer” means at larger radii.

In this text, the term “thread” quite generally denotes, with equal preference, monofilaments or multifilaments or assemblies such as cable, plied yarn or alternatively any type of equivalent assembly and this is true regardless of the material and treatment of these threads, for example a surface treatment or coating or preglueing to enhance adhesion to the rubber.

A reinforcing structure or reinforcement of the carcass type will be said to be radial when its threads are arranged at 90°, but also, according to the terminology in use, at an angle close to 90°.

The characteristics of the thread are to be understood to include, for example, its dimensions, its composition, its mechanical characteristics and properties (particularly its modulus), its chemical characteristics and properties, etc.

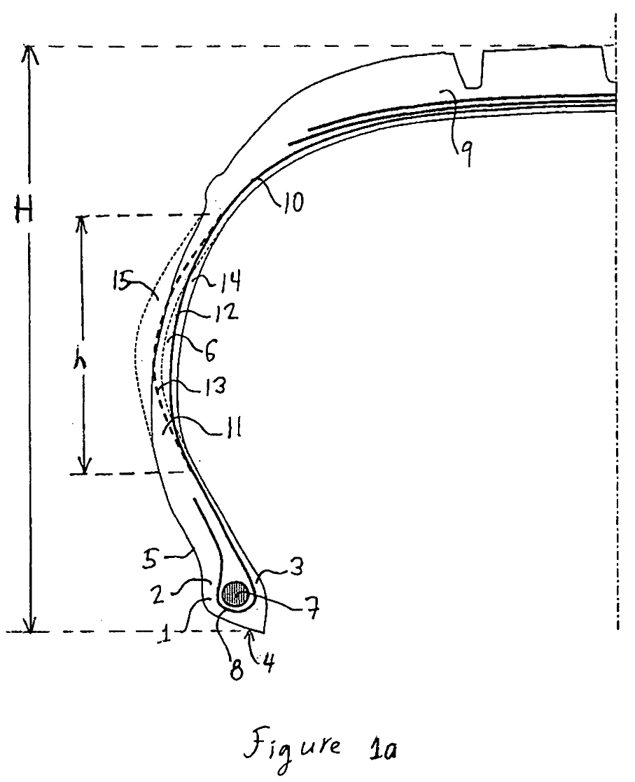

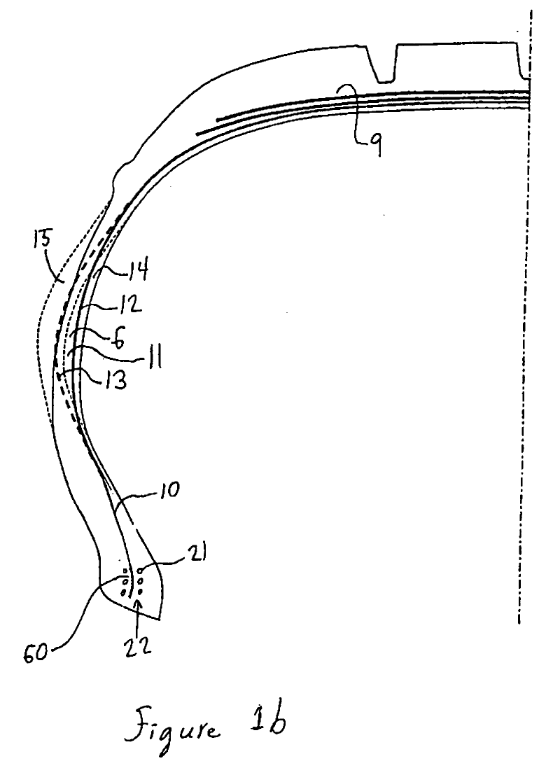

The distance h is the height of the sidewall region 11 with corrugations, as illustrated in FIG. 1.

The distance H in the conventional way represents the height of the tire from the base of the bottom region (i.e., the radially inner point of the tire) as far as the tread, as illustrated in FIG. 1.

The dimension “d” represents the mean diameter of the threads in the reinforcing structure 10.

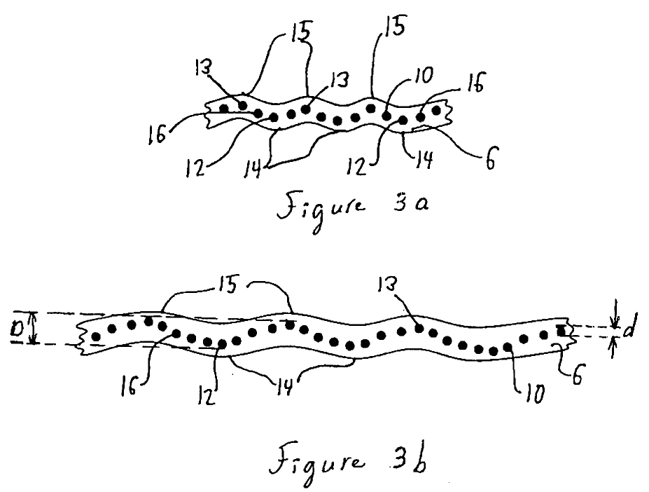

The dimension “D” represents the separational distance between the axially furthermost or opposed positions of the threads in the reinforcing structure along the profile or, in other words, the distance between the outside of the profile of the axially outermost thread and the inside of the profile of the axially innermost thread, as illustrated in FIG. 3b.

FIGS. 1a and 1b illustrate the bottom (i.e., radially inner) region, particularly the bead 1, of a first embodiment of the tire according to the invention. The bead 1 comprises an axially outer portion 2 designed and shaped to be placed against the edge of a rim. The upper or radially outer portion of the portion 2 forms a portion 5 designed to suit the rim flange. This portion is often curved axially outwards, as illustrated in FIG. 1. The portion 2 ends radially and axially towards the inside in a bead seat 4, designed to be positioned against a seat of a rim. The bead also comprises an axially inner portion 3, extending substantially radially from the seat 4 towards the sidewall 6.

The tire also comprises a reinforcing structure 10 or reinforcement of the carcass type provided with reinforcements advantageously configured in a substantially radial arrangement. This structure may be arranged continuously from one bead to the other, passing through the sidewalls and the crown of the tire or, alternatively, it may comprise two or more parts, for example arranged along the sidewalls, without covering the entirety of the crown.

In order to position the reinforcing threads as precisely as possible, it is highly advantageous for the tire to be built up on a rigid support, for example a rigid core that imposes the shape of its interior cavity. All the constituent parts of the tire are applied to this core, in the order required by the final architecture, these constituent parts being positioned directly in their final positions, without the profile of the tire needing to be altered during manufacture.

There are two possible main types of anchorage for the reinforcing structure of the carcass type. Typically, wrapping the said structure 10 around a bead wire 7 in the bead 1 anchors the reinforcing structure of the carcass type into the bead, as illustrated for example in FIG. 1a.

Alternatively, the anchoring function can be achieved using an arrangement of circumferential threads, as illustrated for example in FIG. 1b. Circumferential threads 21 preferably arranged in the form of piles 22, form an arrangement of anchoring threads, provided in each of the beads. These threads are preferably metallic, and possibly coated with brass. Various alternative forms advantageously anticipate threads of a textile nature, such as, for example, threads made of aramid, nylon, PET, PEN or hybrids. In each pile, the threads are advantageously substantially concentric and superposed.

In order to anchor the reinforcing structure perfectly, a laminated composite bead is formed. Inside the bead 1, the circumferentially orientated threads 21 are positioned between the rows of threads of the reinforcing structure. These circumferentially orientated threads are arranged in a pile 22 as in the figures, or in several adjacent piles, or in any sensible arrangement, according to the desired type of tire and/or the desired characteristics.

The radially inner end portions of the reinforcing structure 10 cooperate with the thread windings. This then anchors these portions in the beads. To encourage this anchorage, the space between the circumferential threads and the reinforcing structure is filled with a bonding or anchoring rubber mix 60. It is also possible to use several mixes with different properties, delimiting several regions, the combinations of mixes and the resulting arrangements being practically unlimited. By way of nonlimiting example, the elastic modulus of such a mix may reach or exceed 10 to 15 MPa and even, in some cases, reach or even exceed 40 MPa.

The arrangements of threads may be disposed and manufactured in various ways. For example, a pile may advantageously consist of a single thread wound (substantially at zero degrees) in a spiral over several turns, preferably from the smallest diameter to the largest diameter. A pile may also consist of several concentric threads placed one inside the other, so that rings of gradually increasing diameter are superposed. There is no need to add a rubber mix to impregnate the reinforcing thread or the circumferential windings of threads.

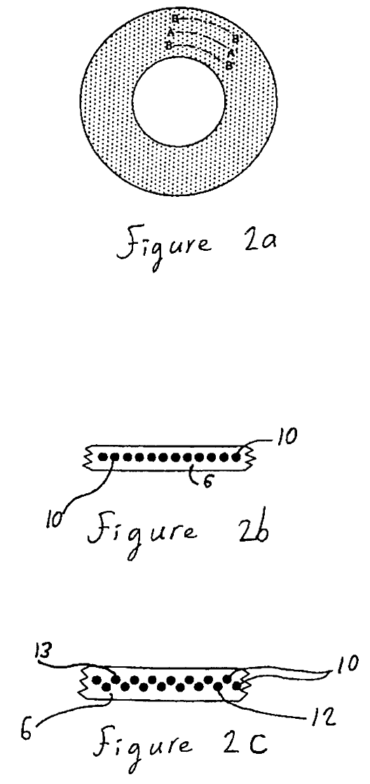

FIGS. 1a and 1b also illustrate the various possible paths of the reinforcing structure of the carcass type 10. A region of sidewall with corrugations 11 extends radially in the sidewall between the bead 1 and the crown region 9. Outside of this region, all the threads of the structure of the carcass type occupy substantially identical axial positions in the sidewall. However, in this region 11, the various threads distributed along the sidewall do not all occupy the same axial position. This is clearly visible in FIGS. 2c, 3a and 3b in addition to FIGS. 1a and 1b. The various possible positions lie between the axially innermost reinforcing structure path 12 and the axially outermost reinforcing structure path 13 (depicted in dotted line).

Between these extreme positions it is possible to find one or more series of intermediate positions 16, such as illustrated for example in FIGS. 3a and 3b. Alternatively, as shown in FIG. 2c, there may be only the extreme positions, without any intermediate position.

FIGS. 2b and 2c clearly illustrate the slight differences or variations in the axial positions of the reinforcing structure threads in the sidewall, according to the radial position therein. Thus, FIG. 2b clearly shows a substantially linear arrangement of the threads in the sidewall, in as much as the threads are being observed outside of the corrugated region, for example in the radial positions B-B′ illustrated in FIG. 2a. FIG. 2c shows the same threads at a radial position substantially corresponding to the corrugated region, such as in the radial position A-A′ illustrated in FIG. 2a for example. The region A-A′ therefore lies in the corrugated region 11 or multi-position range.

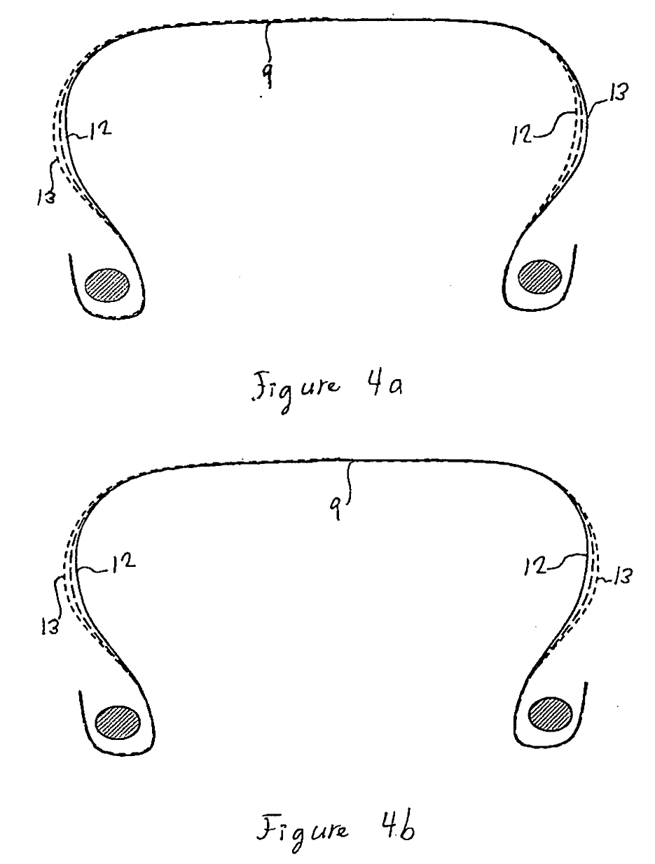

FIGS. 4a and 4b illustrate two examples of the paths of the reinforcing structures of the carcass type from one bead of the tire to the other. In FIG. 4b, the path is symmetric, or similar, on each side of the meridian axis of symmetry of the tire. Thus, the various portions of the corrugations on either side of the tire are aligned: the troughs face the troughs and the peaks face the peaks. Such symmetry exhibits numerous advantages, particularly from the point of view of the behaviour of a statically and dynamically correctly balanced tire.

In 4a, the various portions of the corrugations on each side of the tire are in phase: the troughs of a first side face the peaks of the second side, the peaks of the first side facing the troughs of the second. A asymmetric arrangement such as this exhibits numerous advantages, particularly from the point of view of the manufacture of the tire because all the reinforcing structure portions between the two beads are of equal length, irrespective of the circumferential position, or of whether they are in a trough or a peak.

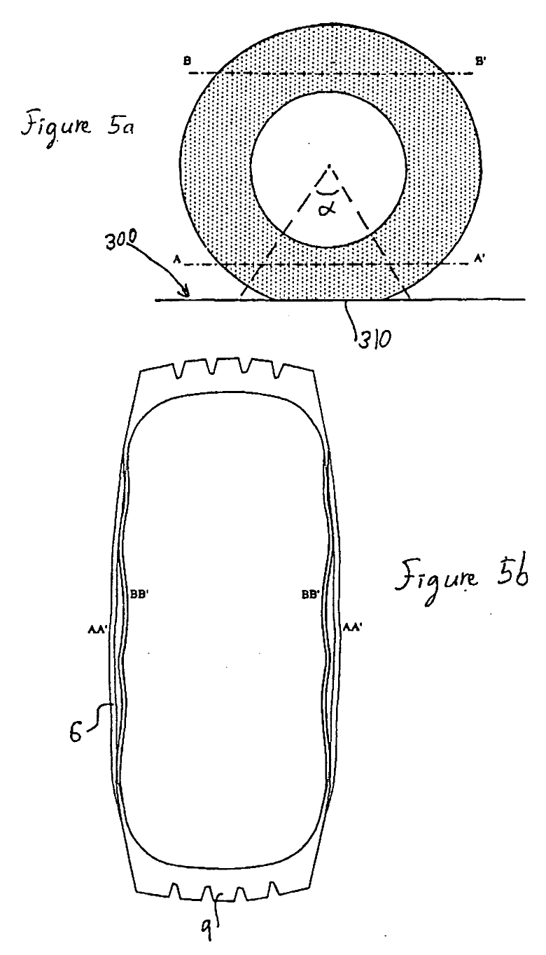

FIGS. 5a and 5b illustrate the influence of the angular position of a tire according to the invention with respect to the ground 30 on the dynamic evolution of the shape and amplitude of the corrugations. In the sidewall region delimited by the angle α, which corresponds substantially to the area of contact 310 with the ground 300, the sidewall is experiencing a mechanical stress which has a tendency to tension, stretch or straighten out the corrugations, as illustrated in FIG. 5b in respect of profile A-A′ shown in dotted line, corresponding to section A-A′ of FIG. 5a. FIG. 5b on the other hand shows, in solid line, the profile B-B′ with the corrugations, corresponding to section B-B′ of FIG. 5a, that is to say in a region not subject to the influence of the contact area.

By drawing a parallel with the dynamic behaviour of a conventional (i.e. without corrugations) radial tire, the following points may be noted. There are numerous mechanical stresses involved in the contact area 31. Between the entry to the contact area and the exit from the contact area, the tire experiences significant elongation stress in the circumferential direction. In the sidewalls, these stresses cause a “deradialization” phenomenon affecting the threads of the reinforcing structure. These threads therefore have a tendency of separate from one another, as a result of elastic stretching of the rubber mix of the sidewall between the threads. This phenomenon itself causes the tire to heat up to a certain extent, and this plays a part in increasing the rolling resistance and affects the durability of the product.

With a tire according to the invention, comprising a sidewall region with corrugations, the same mechanical stresses are introduced between the entry to and the exit from the contact area. However, the corrugations afford a kind of “reserve” of material that is available to respond to the various mechanical stresses that are due to the deformations involved in moving through the contact area, particularly circumferential stresses. This available reserve reduces or, in certain cases, may even avoid the need to resort to stretching of the rubber mix between the threads. What then happens is that the corrugations in the angular region of the tire that correspond to the contact area deform. The said corrugations “flatten out” or reduce in amplitude. The mechanical stresses due to the contact area are therefore somewhat damped or absorbed by the corrugations of the sidewalls. This deformation affords a flexibility that is particularly advantageous in tires with short or very short sidewalls, such as, for example, series 35 or series 40 tires.

A tire according to the invention can be industrially manufactured using several process types. Advantageously, a process involving laying up on a central core is used, either allowing the constituent elements such as the rubber mixes and the reinforcements (threads) to be laid individually, or alternatively allowing the laying of semi-finished products such as reinforced rubber strips. With a process such as this, use is made of a central core that has corrugations in the region substantially corresponding to the region 11 of the tire, thus allowing the sidewalls to be given the corrugated profile or shape as previously described as early in the process as the laying of the various elements.

It is also possible to manufacture the tire using an external mould that comes into contact with the corrugated sidewall. The inside can be moulded using a rigid mould or a flexible membrane, or alternatively using a partially rigid mould consisting, for example, of rigid sections separated by membrane sections.

1-10. (canceled)

11. Tire comprising a tread, a crown reinforcement, two beads, and at least one reinforcing structure of the carcass type anchored on each side of the tire in a bead, the base of which reinforcing structure being configured to be mounted on a rim seat; each bead being extended radially outwards by a sidewall; the sidewalls, radially towards the outside, being joined to the tread; the carcass-type reinforcing structure extending circumferentially from the bead towards the sidewall; each of the beads comprising an anchoring region securing the carcass-type reinforcing structure therein; the carcass-type reinforcing structure comprising threads and being arranged in such a way that in a substantially median region of the sidewall, the threads have different respective axial positions on the circumference so as to form a corrugated thread in the circumferential direction; the carcass-type reinforcement structure arranged such that outside of the substantially median region the threads occupy substantially the same axial position.

12. Tire according to claim 11, in which the substantially median sidewall region having the corrugated thread profile forms a corrugated sidewall profile.

13. Tire according to claim 11 wherein the corrugated thread profile includes axially innermost threads, axially outermost threads, and threads disposed axially therebetween.

14. Tire according to claim 12 wherein the orientation of the corrugated thread profile substantially corresponds to that of the corrugated sidewall profile.

15. Tire according to claim 14 wherein the corrugated sidewall profile is spaced radially outwardly from a respective bead.

16. Tire according to claim 11 wherein the orientation of the corrugated thread profile substantially corresponds to that of the corrugated sidewall profile.

17. Tire according to claim 16 wherein the corrugated thread profile forms alternating troughs and peaks, wherein each trough and peak is substantially axially aligned with a respective trough and peak on the opposite sidewall.

18. Tire according to claim 16 wherein the corrugated thread profile forms alternating troughs and peaks, wherein each trough and peak is substantially axially aligned with a respective peak and trough on the opposite sidewall.

19. Tire according to claim 11 wherein the corrugated thread profile forms alternating troughs and peaks, wherein each trough and peak is substantially axially aligned with a respective trough and peak on the opposite sidewall.

20. Tire according to claim 11 wherein the corrugated thread profile forms alternating troughs and peaks, wherein each trough and peak is substantially axially aligned with a respective peak and trough on the opposite sidewall.

21. Tire according to claim 11 wherein the corrugated thread profile has a height h, and the tread is spaced from a radially inner point of the tire by a height H, wherein h/H ranges between 0.2 and 0.5.

22. Tire according to claim 21 wherein h/H ranges from 0.2 to 0.5.

23. Tire according to claim 11 wherein the threads have a mean diameter d, and an axially outer thread of the corrugated thread profile is spaced axially from an axially inner thread thereof by a distance D which is at least 1.25d.

24. Tire according to claim 23 wherein 1.5d<D<5d.
